(19) United States
(12) Patent Application Publication
(10) Pub. No.: US 2026/0346639 A1
(43) Pub. Date: Nov. 5, 2026

(54) GOLF TROLLEY WHEELS

(71) Applicant: MOTOCADDY LIMITED, Great Hallingbury, Hertfordshire (GB)

(72) Inventors: Cris SIMPSON, Great Hallingbury, Hertfordshire (GB); Paul STRAKER, Great Hallingbury, Hertfordshire (GB); Ian GELL, Great Hallingbury, Hertfordshire (GB)

(73) Assignee: MOTOCADDY LIMITED, Great Hallingbury, Hertfordshire (GB)

(21) Appl. No.: 19/099,258

(22) PCT Filed: Jul. 20, 2023
(86) PCT No.: PCT/EP2023/070200

§ 371 Date: Jan. 28, 2025

(30) Foreign Application Priority Data
Jul. 29, 2022 (GB) 2211140.5

(51) Int. Cl. B60B 15/02

(52) U.S. Cl. CPC B60B 15/02; B60B 2900/721

(57) ABSTRACT

A golf trolley wheel having a hub configured to receive an axle of a golf trolley, in use. An openwork support of the golf trolley wheel extends from the hub and includes one or more circumferential openings. A plurality of distinct feet are mounted on and radially protrude from the openwork support.

### FIELD

The present invention relates to golf trolley wheels, in particular all weather golf trolley wheels, wet weather golf trolley wheels, and to golf trolleys comprising the same. The present invention also relates to detachable treads for golf trolley wheels.

### BACKGROUND

Electric, i.e. powered, golf trolleys are traditionally banned from golf courses during wet weather or winter months in order to minimise damage to the golf course. This is because conventional flat-tyred wheels, driven by an electric golf trolley motor, typically flatten, bruise and break grass, create bald patches on the course and spread mud around the course as it is collected on the wheels of the golf trolley and redistributed.

Also, as mud and leaves are picked up and collect on golf trolley wheels when the course is wet, wheels become clogged and grip is lost. This causes wheels to spin freely under the torque of the trolley's motor, which exacerbates the above problems.

Keeping wheels from getting clogged with mud, leaves and the like is also crucial for driveability. This is particularly important now that an electric golf trolley may be somewhat autonomous, and it may therefore be situated and operating away from, i.e. not under the manual control of, the golfer during play.

There is also a need to minimise the amount of mud and leaf pick-up so that golfers' vehicles and other equipment are not soiled.

This has been a long standing challenge and attempts to address it include providing golf trolley wheels comprising studs or projections, deep treads or cut outs in their tyres in an effort to improve or maintain grip while minimising harmful contact with the course surface.

However, these known attempts still suffer from at least some of the above issues.

Accordingly, there is an ongoing need to address the above described issues and provide golf trolley wheels, and golf trolleys, which do not cause an unacceptable level of disturbance to golf courses and which maintain an adequate level of golf trolley driveability and cleanliness.

The present invention aims to solve these and other problems with the prior art.

### SUMMARY

Accordingly, in a first aspect, the present invention provides a golf trolley wheel comprising a hub configured to receive an axle of a golf trolley, in use; an openwork support extending from the hub and including one or more circumferential openings; and a plurality of distinct feet mounted on and radially protruding from the openwork support.

This configuration is particularly advantageous because less matter, e.g. mud, grass and leaves, is collected by the wheel as it travels on wet ground. Thus, a golf trolley causes less damage to a golf course, particularly when the course is wet. Driveability is also improved. In particular, the wheel is less likely to lose traction because less mud and/or grass and/or leaves sticks to the wheel during use. The vehicle and other equipment belonging to the golfer are also less likely to be soiled.

More specifically, the combination of the openwork support including one or more circumferential openings and the plurality of radially outwardly protruding distinct feet of the golf trolley wheel reduces or prevents the amount of mud, leaves or similar which can stick to the wheel (and which could be subsequently redistributed about a golf course). In comparison, a golf trolley wheel including either a conventional closed support, i.e. a non-openwork support, or a track, i.e. non-distinct feet, will collect more matter and result in the problems described above.

As used herein, the term openwork refers to the support having an open structure so that matter may pass therethrough, in particular through the surface which is substantially parallel to the ground during play. In other words, the golf trolley wheel comprises a reduced amount of material within the ‘interior’ space defined by the openwork support and plurality of distinct feet. The combination of the openwork support and the plurality of distinct feet provides the described advantages.

As used herein, the term distinct feet refers to each of the feet not being in materially direct contact with another foot. Typically, the plurality of distinct feet are not integrally formed with one another. Typically, each said foot is a single piece, separately mounted to and protruding radially from the openwork support.

Because each of the plurality of distinct feet protrudes radially from the openwork support, it is the feet rather than the openwork support which typically contact the ground during use, or at least form the primary points of contact with the ground. The openwork support is not typically configured to contact the ground and provide traction. Instead, the openwork support is typically configured to support each of the plurality of distinct feet which contact the ground and provide traction. The distinct, i.e. separate, feet allow for a continuous contact point between the golf trolley wheel and the ground. Typically, a golf trolley wheel includes two of the wheels and a continuous contact point exists between each of the wheels and the ground.

Advantageously, the golf trolley wheel is also lighter and requires less material.

Typically, the golf trolley wheel may be a non-pneumatic, i.e. airless, wheel.

In embodiments, the golf trolley wheel may have a substantially uniform effective radius. In other words, the golf trolley wheel, and in particular the distinct feet thereof, may be configured such that the height of the axis of rotation of the wheel above the ground on which the wheel is located remains substantially constant through a rotation of the wheel. This may assume a substantially constant load on the wheel and/or substantially uniform terrain during rotation thereof.

In embodiments, the golf trolley wheel may have a substantially uniform radius. In other words, the distance between the axis of rotation and a radially outermost surface of the golf trolley wheel (e.g. at a radial cross section) may be substantially the same about the circumference of the wheel. In particular, the plurality of distinct feet may be arranged such that the radius of the wheel is substantially constant.

For example, each distinct foot may circumferentially overlaps with a portion of an adjacent distinct foot such that the radius of the golf trolley wheel is substantially uniform.

In embodiments, at least one said distinct foot may have a substantially dissimilar shape and/or orientation on the openwork support relative to at least one other said foot. This configuration is particularly advantageous because a regular tread pattern is not imprinted on a golf course. The configuration of the golf trolley wheel prevents the same tread footprint being applied to the ground, thus slowing down or arresting a worsening in the condition of the golf course, particularly during wet weather.

In embodiments, at least two adjacent feet may have a substantially dissimilar shape and/or orientation on the openwork support relative to one another. In embodiments, the two adjacent distinct feet may be rotationally adjacent feet and/or axially adjacent feet.

As used herein, the term axially adjacent means those feet which are adjacent in a plane substantially parallel to the axis of rotation of the golf trolley wheel.

In embodiments, a first said foot may have a substantially dissimilar shape and/or orientation on the openwork support relative to each other said foot of the golf trolley wheel. Thus, each of the distinct feet may have a unique combination of shape and orientation on the openwork support. In embodiments, two or more of the distinct feet may have a substantially similar shape and orientation to one another and a substantially dissimilar shape and/or orientation to at least one other, optionally a plurality of other, said distinct feet.

In other words, the golf trolley wheel may have a substantially irregular circumferential configuration.

The golf trolley wheel may have a non-repeated arrangement of distinct feet over at least a quarter, preferably at least a half, more preferably the entire circumference of the wheel. In other words, in embodiments, the golf trolley wheel may have a substantially irregular or non-uniform tread configuration through at least a quarter, preferably through at least a half, more preferably through the entirety of the circumference of the wheel.

In embodiments, the golf trolley wheel may comprise a plurality of distinct feet which have a relatively regular configuration, i.e. which have a repeated shape and/or orientation on the openwork support, and a plurality of distinct feet which have a relatively irregular configuration. For example, the golf trolley wheel may comprise one or more circumferential sections of distinct feet which have a substantially irregular layout in themselves but which are repeated about the circumference of the wheel. For example, the golf trolley wheel may comprise two repeats of a circumferential section which itself has a substantially irregular configuration, i.e. a plurality of distinct feet wherein at least one distinct foot has a substantially dissimilar shape and/or orientation to at least one other distinct foot in the section.

In embodiments, the plurality of distinct feet may be arranged such that the golf trolley wheel is substantially asymmetrical about a circumferential centre line thereof. The golf trolley wheel therefore has a substantially asymmetrical tread, which helps to reduce the risk of damage to a golf course.

In embodiments, rotationally adjacent feet may be arranged substantially on opposing sides of the circumferential centre line. Thus, the ground may be contacted sequentially by distinct feet located on opposing hemispheres of the golf trolley wheel in order to minimise contact with the ground over substantially the whole width of the wheel.

As used herein, the term rotationally adjacent refers to distinct feet which contact the ground immediately following one another, depending on the direction of rotation of the golf trolley wheel.

In embodiments, the plurality of distinct feet may be arranged such that a first radial cross section of the wheel has a substantially dissimilar profile to any other radial cross section of the wheel.

In other words, the plurality of distinct feet may be arranged such that a first radial cross section of the wheel has a substantially unique profile relative to the profile of a rotationally subsequent quarter of the wheel.

In embodiments, the plurality of distinct feet may be arranged such that a first radial cross section of the wheel has a substantially unique profile relative to the profile of a rotationally subsequent half of the wheel.

In embodiments, the plurality of distinct feet may be arranged such that a first radial cross section of the wheel has a substantially unique profile relative to the profile of substantially the entire remainder of the wheel.

In embodiments, a footprint of the golf trolley wheel may be comprised of at least a portion of one said foot. In embodiments, a footprint of the golf trolley wheel may be comprised of at least a portion of two or more said feet. In other words, two said feet may be in contact with the ground at any moment during travel. Preferably, a footprint of the golf trolley wheel may be comprised of at least a portion of three or more said feet. The stability of the golf trolley wheel is thereby improved while minimising the contact surface area.

As used herein, the term footprint refers to that part of the golf trolley wheel which is in contact with the ground at a given moment in time as the golf trolley wheel rotates, in use. The footprint may also be referred to as the contact area or the contact patch.

In embodiments, the golf trolley wheel may comprise two or more axially adjacent rows of said distinct feet. In embodiments the golf trolley wheel may comprise three axially adjacent rows of said distinct feet. In embodiments, the golf trolley wheel may comprise more than three axially adjacent rows of said distinct feet. Each axially adjacent row of said distinct feet may extend substantially around the circumference of the golf trolley wheel. In embodiments, the axially adjacent rows of said distinct feet are substantially axially evenly spaced.

In other embodiments, the golf trolley wheel may comprise three or more adjacent rows of said distinct feet. Typically, each said row may comprise substantially the same number of distinct feet thereon. However, it is envisaged that adjacent rows may have a differing number of said distinct feet thereon.

In embodiments, the distinct feet of a first row may be circumferentially offset with respect to the distinct feet of a further row adjacent the first said row. In other words, a distinct foot on a first row may be axially adjacent a gap between two other distinct feet on a second, adjacent row of the golf trolley wheel. This configuration is particularly advantageous because it improves the smooth rolling of the golf trolley wheel while minimising the footprint of the golf trolley wheel.

In embodiments, the feet of a first row may be substantially axially symmetrical with the feet of a second row. In embodiments, the symmetrical rows may be adjacent or may be separated by a third row whose feet are circumferentially offset with respect to the feet of the first and second rows.

In embodiments, at least one said foot may be substantially elongate. Preferably, each said foot may be substantially elongate.

In embodiments, at least one said foot may be radially shorter than it is long. Preferably, each said foot may be radially shorter than it is long. This configuration is particularly advantageous because the load of the golf trolleys is spread across the length of the elongate foot, and the foot is thus less likely to sink into the ground and cause damage to it.

In embodiments, at least one said elongate foot may be substantially axially bowed. Thus, the axial and/or circumferential extension of an elongate foot may vary along its length. In other words, in embodiments at least one said foot may be substantially ‘lozenge’ shaped and another said foot may be substantially ‘banana’ shaped.

In embodiments, at least one said foot may include a radially outward ridge and a radially inward base, and said foot may be substantially wider at the base than at the ridge. Preferably, each said foot may include a radially outward ridge and a radially inward base and each said foot may be substantially wider at the base than at the ridge.

In embodiments, each said foot inclines substantially uniformly towards the ridge from the base thereof. This configuration is particularly advantageous because the distinct feet may therefore contact (potentially puncturing and exiting) the ground more smoothly during use, thereby picking up less mud, grass and leaves.

In embodiments, each said foot may be substantially triangular-prism shaped. In embodiments, each said foot may comprise substantially rounded or chamfered edges.

In embodiments, a ground-contact surface of each foot may extend from the ridge to the base thereof and may extend substantially about the perimeter of the foot. In other words, substantially the entire outer-facing surface of a said foot may comprise a ground-contact surface.

In embodiments, at least one said foot may be radially arced such that the golf trolley wheel has a substantially circular rolling circumference. Preferably, each said foot may be radially arced. This configuration is particularly advantageous because the smooth rolling of the golf trolley wheel on the ground is improved, in use.

In embodiments, the openwork support may comprise a single circumferential opening. In other words, the openwork support may be devoid of a plurality of distinct cut outs or the like. Instead, each of the radially protruding feet may be separated from one another by a common opening or void. Matter, e.g. mud and leaves, may therefore more freely move between the distinct feet and through the openwork support.

In embodiments, at least part of the openwork support may comprise a plurality of legs which extend between the hub and each of the plurality of distinct feet. This configuration is particularly advantageous because the distinct feet need not necessarily be mounted on a circumferential mat or frame, or the like, which may include one or more rims.

In embodiments, the golf trolley wheel may comprise two or more axially adjacent rows of said distinct feet and substantially axially adjacent feet may be mounted on a common leg. Pairs of axially adjacent distinct feet may therefore share a leg which extends from the hub. The number and sizes of the legs provides strength to the or each rim, if present.

In embodiments, each said foot may be mounted on a corresponding distinct leg.

In embodiments, the golf trolley wheel may comprise a plurality of legs on which the distinct feet may be mounted, wherein the plurality of legs has a substantially concertinaed configuration.

In embodiments, the plurality of legs may be substantially integrally formed. In other words the plurality of legs may be joined to one another.

In embodiments, at least part of the openwork support may comprise a circumferential frame, typically located towards an outer diameter of the golf trolley wheel, on which the plurality of distinct feet are mounted. This advantageously improves the manufacturing process of the golf trolley wheel. For example, the openwork support may be more straightforwardly moulded. In embodiments, the golf trolley wheel may be at least partially formed by an injection moulding process. In embodiments, the golf trolley wheel may be substantially entirely formed by an injection moulding process.

In embodiments, the wheel may be substantially rimless. The golf trolley wheel may therefore be substantially open at its axial ends. Mud, leaves and grass is therefore less easily picked up by the golf trolley wheel, and a less visible or damaging path is created as the golf trolley to which the wheel is mounted travels, in use.

In embodiments, the openwork support may comprise one or more rims at or towards the inner and/or outer axial end of the golf trolley wheel. Typically, therefore, each of the plurality of distinct feet protrudes radially outwardly beyond the or each rim.

In embodiments, the openwork support may comprise one or more interconnecting struts which extend between adjacent distinct feet. In embodiments, the one or more interconnecting struts may extends between rotationally adjacent distinct feet. In embodiments, the openwork support may comprise a plurality of interconnecting struts. The interconnecting struts may be substantially evenly spaced about the circumference of the golf trolley wheel. In embodiments, the plurality of interconnecting struts may be substantially unevenly, e.g. randomly, spaced about the circumference of the golf trolley wheel. The or each interconnecting strut support the distinct feet.

In embodiments, the openwork support may comprise a plurality of corresponding base plates on which each of the plurality of distinct feet is mounted.

In embodiments, the openwork support may comprise one or more spokes which extend between the hub and the or each rim. The or each spoke provides structural support to the or each rim.

In embodiments, the golf trolley wheel may include eighteen distinct feet. In embodiments, the golf trolley wheel may comprise two axially adjacent rows each including nine distinct feet.

In embodiments, the golf trolley wheel may be comprised substantially of a composite material. In embodiments, the golf trolley wheel may be comprised substantially of plastic.

In embodiments, the distinct feet may be comprised substantially of rubber.

In embodiments, the distinct feet may be detachable from the openwork support.

In embodiments, the wheel may be resiliently deformable. For example, the wheel may have a degree of flexibility sufficient to absorb or partially absorb, i.e. conform to, changes in terrain so that a ride height of the golf trolley remains substantially constant.

In embodiments, the wheel or portions thereof may be formed of a cellular material, e.g. a material including a porous microstructure. Thus, the wheel may be lighter and/or may better conform to changes in terrain.

In a further aspect, the present invention provides a golf trolley comprising one or more golf trolley wheels according to any preceding embodiment.

Typically, the golf trolley may comprise a plurality of said wheels, and preferably two wheels, the two wheels being attached to opposing ends of an axle of the golf trolley via their respective hubs. In embodiments, the golf trolley may comprise two said wheels at either end of an axle. In embodiments, the two wheels may have substantially the same configuration of distinct feet.

In embodiments, the golf trolley may be an electric golf trolley. Typically two said wheels are driven wheels, i.e. their rotation is powered by the electric golf trolley motor. Typically, the golf trolley may comprise a front wheel. The front wheel is typically a passive wheel. The front wheel may be a wheel in accordance with any preceding aspect.

In a further aspect, the present invention provides a detachable tread for a golf trolley wheel comprising a substantially tubular support and plurality of distinct feet radially protruding from said support, the plurality of distinct feet being in accordance with those of any preceding aspect. The plurality of distinct feet have a substantially irregular, or non-uniform, arrangement on the substantially tubular support. In other words, at least one said foot has a substantially dissimilar shape and/or orientation on the openwork support relative to at least one other said foot. The detachable tread is effectively a wraparound sleeve which bounds an outer circumferential surface of the golf trolley wheel to which it is attached. The detachable tread may also be referred to as a wraparound wheel attachment cover. Typically, the detachable tread is removably attached to a golf trolley wheel.

In other words, the present invention provides a detachable tread including a plurality of distinct feet mounted and radially protruding from a tubular support which can be retrofitted to an existing golf trolley wheel. At least one of the distinct feet of the golf trolley wheel cover may have a dissimilar shape and/or orientation with respect to at least one other of the distinct feet. In embodiments, each of the distinct feet of the golf trolley wheel cover may have a dissimilar shape and/or orientation with respect to each other of the distinct feet.

In embodiments, the detachable tread may be substantially elastic. In other words, the detachable tread may be configured to stretch over and fit tightly to a golf trolley wheel such that the cover does not detach from the wheel during normal use. In other words, the tubular support may have a substantially smaller internal diameter than the external diameter of a golf trolley wheel to which it is configured to be attached. This detachable tread may be configured to attach to a wheel of a push-type golf trolley and/or a powered, e.g. electric, golf trolley wheel. In embodiments, the detachable tread may comprise fixing means, e.g. pins, for fixing, preferably reversibly, the cover to the wheel of a golf trolley.

In embodiments, the golf trolley wheel cover may be substantially comprised of rubber.

In a further aspect, the present invention provides a kit comprising one or more feet for a golf trolley wheel or a golf trolley wheel cover in accordance with any preceding aspect.

In a further aspect, the present invention provides a kit comprising two or more golf trolley wheels or golf trolley wheel covers in accordance with any preceding aspect.

In embodiments, the kit may comprise two golf trolley wheels and an axle for a golf trolley; wherein the two golf trolley wheels are mountable on opposing ends of the axle.

For the avoidance of doubt, features of aspects and embodiments described herein may be combined, and still fall within the scope of the present invention.

### BRIEF DESCRIPTION OF FIGURES

Preferred features of the present invention will now be described, by way of example, with reference to the accompanying drawings, in which:

FIG. 1 illustrates a perspective view of a golf trolley wheel in accordance with the present invention.

FIG. 2 illustrates a side on view of the golf trolley wheel of FIG. 1.

FIG. 3 illustrates a top down view of a golf trolley including two golf trolley wheels of FIG. 1 and FIG. 2.

FIG. 4 illustrates a perspective view of a golf trolley including two golf trolley wheels of FIG. 1 and FIG. 2.

FIG. 5 illustrates a perspective view of a further golf trolley wheel in accordance with the present invention.

FIG. 6 illustrates a side-on view of the golf trolley wheel of FIG. 5.

FIG. 7 illustrates a front-on view of the golf trolley wheel of FIG. 5 and FIG. 6.

### DETAILED DESCRIPTION

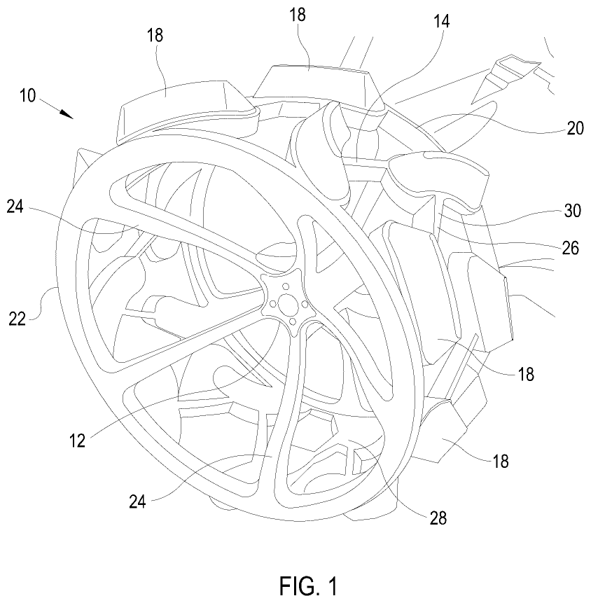

FIGS. 1 to 4 show a golf trolley wheel in accordance with the present invention, generally referenced 10. The golf trolley wheel is configured for use in all weathers, including when the ground at a golf course may be wet and/or muddy. Therefore, the golf trolley wheel may be referred to as an all-weather wheel. The golf trolley wheel may also be referred to as a wet weather wheel, although, of course, the wheel may be used in all conditions generally expected on a playable golf course.

The golf trolley wheel 10 comprises a hub 12 configured to receive an axle of a golf trolley, in use. The golf trolley wheel 10 further comprises an openwork support 14 and a plurality of distinct feet 18. The openwork support 14 extends from the hub 12. The distinct feet 18 are mounted on and radially protrude from the openwork support 14.

The openwork support 14 of the golf trolley wheel 10 of FIGS. 1 to 4 comprises an inner rim 20, an outer rim 22 and a plurality of spokes 24 which extend between each of the rims 20, 22 and the hub 12. The hub 12 the outer rim 22 extends axially more outwardly than the hub 12, which tends to reduce the amount of mud and/or leaves which collects on the wheel 10.

The inner and outer rims 20, 22 define the axially inner and outer ends of the wheel 10.

The openwork support 14 further comprises a circumferential frame 26 on which the plurality of distinct feet 18 are mounted and from which the plurality of distinct feet radially protrude. The circumferential frame 26 comprises a set of base plates 28 on which the distinct feet 18 are mounted. A plurality of interconnecting struts 30 extend between the base plates of rotationally adjacent distinct feet 18, i.e. distinct feet which contact the ground immediately after one another depending on the direction of rotation of the wheel 10. The hub 12, rims 20, 22, spokes 24 and circumferential frame 26 may be integrally formed. For example the golf trolley wheel may be formed substantially by moulding, and more specifically by injection moulding.

The combination of the openwork support 14 and the plurality of distinct feet 18 which protrude radially means that mud and other matter, e.g. grass and leaves, has less to stick to and collect on as the golf trolley wheel 10 traverses wet or muddy ground. In particular, the openwork frame has at least one circumferential opening so that matter may pass therethrough, and between the plurality of distinct feet. In the golf trolley wheel 10 of FIGS. 1 to 4, the openwork support 14 includes a plurality of circumferential openings between adjacent distinct feet 18.

As stated, the distinct feet 18 protrude radially outwardly from the openwork support 14. One or more of the distinct feet 18 have a substantially dissimilar shape and/or orientation to one or more of the other distinct feet 18 of the wheel 10. In the embodiment of FIGS. 1 to 4, each of the distinct feet 18 of the wheel 10 has a unique shape and orientation on the openwork support 10. While some of the distinct feet 10 may have a substantially similar shape, their orientation is substantially dissimilar, and while other distinct feet 10 may have a substantially similar orientation on the openwork support 14, their shape is substantially dissimilar. The golf trolley wheel 10 therefore has a substantially irregular configuration about its circumference. A regular imprint is therefore not made and left in the grass of a golf course as the golf trolley travels.

The golf trolley wheel 10, and in particular the arrangement of the plurality of distinct feet 18, is substantially asymmetrical about a circumferential centre line of the wheel 10.

More specifically, rotationally adjacent distinct feet 18 are arranged substantially on opposing sides of the circumferential centre line so that, during use, the ground is contacted sequentially by distinct feet 18 located on opposing sides of the circumferential centre line in order to minimise contact between the wheel 10 and the ground over the width of the wheel 10.

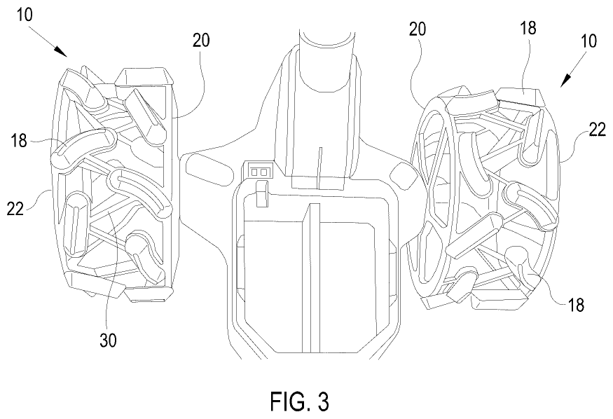

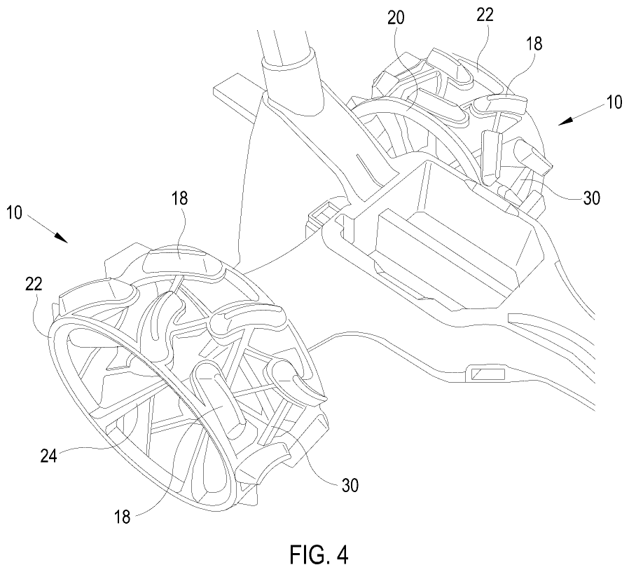

Even more specifically, the golf trolley wheel 10 comprises two axially adjacent rows of distinct feet 18 which extend substantially around the circumference of the wheel 10. As can be seen from FIGS. 3 and 4 in particular, the distinct feet 18 of axially adjacent rows may overlap the circumferential centre line of the wheel 10, depending on the shape and/or orientation of the foot.

In the embodiment of FIGS. 1 to 4, each row includes nine distinct feet 18 (eighteen distinct feet in total). The rows are arranged such that the distinct feet of adjacent rows are circumferentially offset. In other words, a distinct foot on a first row is axially adjacent a gap between two distinct feet of the adjacent row.

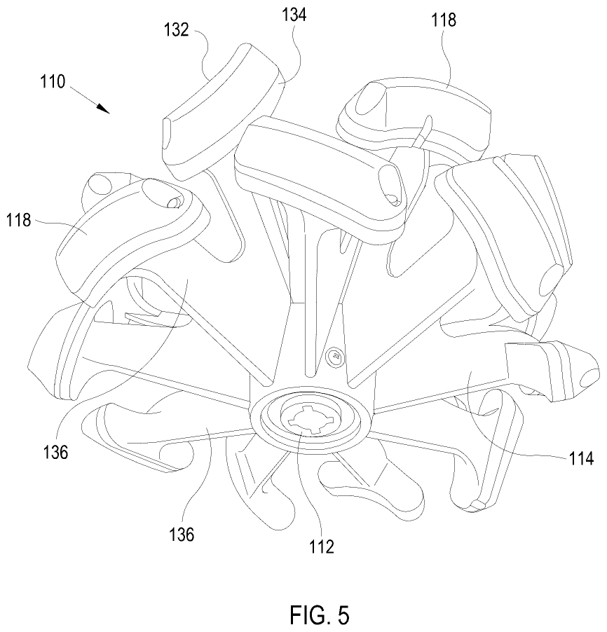

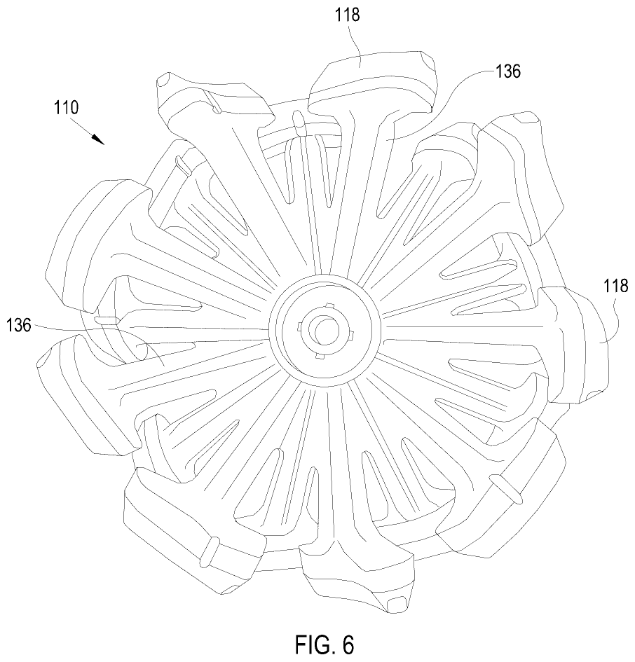

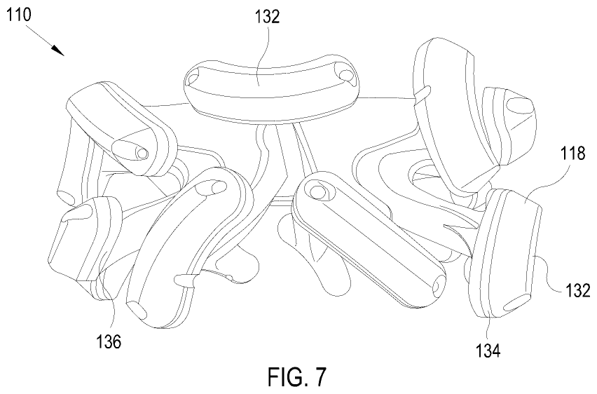

FIGS. 5 to 7 show a further golf trolley wheel 110 in accordance with the present invention.

The golf trolley wheel 110 of FIGS. 5 to 7 also comprises a hub 112, an openwork support 114 extending from the hub 112 and a plurality of distinct feet 118 which are mounted to and radially protrude from the openwork support 114.

The golf trolley wheel 110 of FIGS. 5 to 7 differs from the golf trolley wheel of FIGS. 1 to 4 in that the openwork support 114 does not comprise a circumferential frame. Instead, the openwork support 114 comprises a plurality of legs 136 which extend from the hub 112. Each of the plurality of distinct feet 118 is mounted to a corresponding leg 136.

The openwork support 114 of the golf trolley wheel 110 of FIGS. 5 to 7 therefore comprises a single circumferential opening which extends substantially around the entire circumference of the golf trolley wheel 110.

As can be seen from FIG. 5 in particular, the legs 136 of the openwork support 114 are joined to one another. The openwork support 114 has a substantially concertinaed configuration. The concertinaed configuration of the legs 136 provides two axially adjacent rows of distinct feet 118 about the circumference of the wheel 110. Adjacent legs 136 and their corresponding feet 118 are therefore located on opposing sides of the circumferential centre line of the golf trolley wheel 110.

At their most radially outward point, each leg 136 of the openwork support 114 is typically spaced around 70 mm from the most radially outward point of each adjacent leg 136.

The golf trolley wheel 110 is also rimless in that it does not include an inner or an outer rim as part of the openwork support 114.

The distinct feet 118 of the golf trolley wheel 110 are similar in form to those of the golf trolley wheel 10 of FIGS. 1 to 4.

In each case, the plurality of distinct feet 18, 118 are arranged such that the footprint of the golf trolley wheel 10, 110, i.e. that part of the wheel 10, 110 which is in contact with the ground at a given moment in time during rotation of the wheel 10, 110, is comprised of at least a portion of three of the distinct feet 18, 118.

Due to the uniqueness of the shape and orientation of each of the distinct feet 18, 118, and therefore the circumferential configuration of the wheel 10, 110, a first radial cross section of the wheel 10, 110 has a substantially dissimilar profile to any other radial cross section of the wheel. However, it is envisaged that a lesser degree of irregularity could be present. For example, two or more of the distinct feet 18, 118 may have a substantially similar shape and orientation on the openwork support 14, 114. Thus, two or more radial cross sections of the wheel 10, 110 may have a substantially similar profile while retaining the advantages of the described above.

Each of the plurality of distinct feet 18, 118 is substantially elongate and is radially shorter than it is long. Several of the distinct feet 18, 118 are relatively straight while several other of the distinct feet 18, 118 are axially bowed, i.e. curved. In other words, some of the distinct feet 18, 118 are ‘lozenge’ shaped, while some of the distinct feet 18, 118 are ‘banana’shaped.

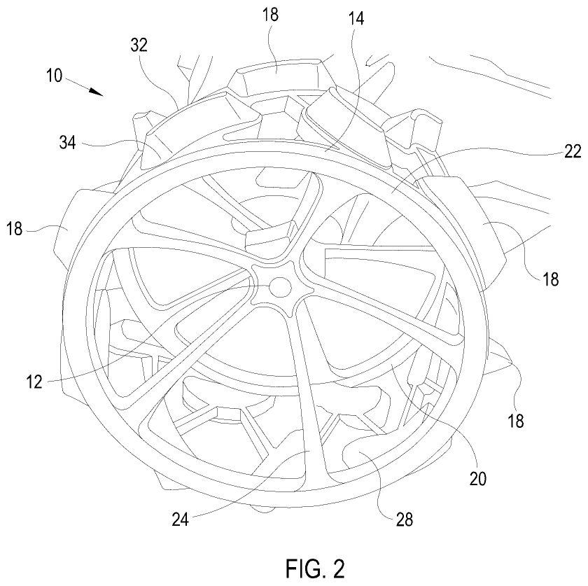

With particular reference to FIGS. 2 and 5, each of the distinct feet 18, 118 has a radially more outward ridge 32, 132 and a radially more inward base 34, 134, and each is substantially wider at its base than at its ride. Each distinct foot 18, 118 is inclined, substantially uniformly, between its base 34, 134 and its ridge 32, 132. Thus, broadly speaking, each of the feet 18, 118 substantially has the shape of a triangular prism, with one elongate side of each triangular-prism shaped foot 18, 118 being attached to the openwork support 14, 114 and the other two elongate sides of the triangular-prism shaped foot 18, 118 forming a ground-contact surface.

Each of the edges and/or corners of each distinct foot 18, 118 is also typically rounded or chamfered to further improve smooth interaction with the ground as the wheel 10 rotates, in use.

Furthermore, each of the distinct feet 18, 118 is radially arced in order that the golf trolley wheel 10, 110 has a substantially circular rolling circumference.

In each case, the golf trolley wheel 10, 110 is formed substantially of plastic, although other suitable materials are envisaged. Each of the distinct feet 18, 118 is typically formed substantially of rubber.

The golf trolley wheel 10, 110 typically has a diameter of between around 250 mm to around 350 mm, more preferably between around 270 mm to around 300 mm.

The golf trolley wheel 10, 110 typically has a width of at least around 90 mm.

Each of the distinct feet 18, 118 may be detachable from the openwork support 14, 114. However, typically, the each of the distinct feet 18, 118 is substantially permanently attached to the openwork support 14, 114. For example, each of the distinct feet 18, 118 may be over moulded onto the openwork support 18, 118. In the golf trolley wheel 10 of FIGS. 1 to 4, the feet 18 are substantially permanently attached to the openwork support 14, whereas in the golf trolley wheel 110 of FIGS. 5 to 7, the feet 18 are detachably connected to the legs 136 of the openwork support 114. In summary, it is envisaged that the feet 18, 118 of either golf trolley wheel 10, 110 could be permanently or detachably connected to the openwork support 14, 114.

Typically, a golf trolley (usually an electric golf trolley) will comprise two of the described golf trolley wheels 10, 110 as rear driven wheels.

1-24. (canceled)

25. A golf trolley wheel comprising:
a hub configured to receive an axle of a golf trolley, in use;
an openwork support extending from the hub and including one or more circumferential openings; and
a plurality of distinct feet mounted on and radially protruding from the openwork support.

26. The golf trolley wheel according to claim 25, wherein at least one foot of said plurality of distinct feet has a substantially dissimilar shape and/or orientation on the openwork support relative to another foot of said plurality of distinct feet.

27. The golf trolley wheel according to claim 25, wherein at least two adjacent feet of said plurality of distinct feet have a substantially dissimilar shape and/or orientation on the openwork support relative to one another.

28. The golf trolley wheel according to claim 25, wherein a first foot of said plurality of distinct feet has a substantially dissimilar shape and/or orientation on the openwork support relative to each other foot of said plurality of distinct feet of the golf trolley wheel.

29. The golf trolley wheel according to claim 25, wherein the plurality of distinct feet are arranged such that the golf trolley wheel is substantially asymmetrical about a circumferential center line thereof.

30. The golf trolley wheel according to claim 29, wherein rotationally adjacent feet of the plurality of distinct feet are arranged substantially on opposing sides of the circumferential center line.

31. The golf trolley wheel according to claim 25, wherein the plurality of distinct feet are arranged such that a first radial cross section of the wheel has a substantially dissimilar profile to any other radial cross section of the wheel.

32. The golf trolley wheel according to claim 25, wherein a footprint of the golf trolley wheel is comprised of at least a portion of two or more of said plurality of distinct feet.

33. The golf trolley wheel according to claim 25, comprising two or more axially adjacent rows of said distinct feet; optionally, wherein the distinct feet of a first row of the two of more rows are circumferentially offset with respect to the distinct feet of a further row adjacent the first said row.

34. The golf trolley wheel according to claim 25, wherein at least one foot of said plurality of distinct feet is substantially elongate; optionally, wherein at least one said foot is radially shorter than a length dimension thereof; further optionally wherein said at least one foot is substantially axially bowed.

35. The golf trolley wheel according to claim 25, wherein at least one foot of said plurality of distinct feet includes a radially outward ridge and a radially inward base, and said at least one foot is substantially wider at the inward base than at the outward ridge.

36. The golf trolley wheel according to claim 25, wherein at least one foot of said plurality of distinct feet is radially arced such that the golf trolley wheel has a substantially circular rolling circumference.

37. The golf trolley wheel according to claim 25, wherein each distinct foot circumferentially overlaps with a portion of an adjacent distinct foot such that a radius of the golf trolley wheel is substantially uniform about a circumference thereof.

38. The golf trolley wheel according to claim 25, wherein the openwork support comprises a single circumferential opening.

39. The golf trolley wheel according to claim 25, wherein at least part of the openwork support comprises a plurality of legs which extend between the hub and each of the plurality of distinct feet.

40. The golf trolley wheel according to claim 39, further comprising two or more axially adjacent rows of said distinct feet, wherein substantially axially adjacent feet of said plurality of distinct feet are mounted on a common leg.

41. The golf trolley wheel according to claim 15, wherein each foot of said plurality of distinct feet is mounted on a distinct corresponding leg.

42. The golf trolley wheel according to claim 25, wherein at least part of the openwork support comprises a circumferential frame on which the plurality of distinct feet are mounted.

43. The golf trolley wheel according to claim 25, wherein the wheel is substantially rimless.

44. A golf trolley comprising one or more of the golf trolley wheels according to claim 25; optionally, wherein the golf trolley is an electric golf trolley.
